(19) United States
(12) Patent Application Publication
(10) Pub. No.: US 2008/0031473 A1
(43) Pub. Date: Feb. 7, 2008

(54) Method of providing listener with sounds in phase and apparatus thereof

(75) Inventors: Sergey Yarygin, Krasnodar (RU); Vladislav Shimanskiy, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/657,537

(22) Filed: Jan. 25, 2007

(30) Foreign Application Priority Data
Aug. 4, 2006 (KR) 2006-73761

(51) Int. Cl. H04R 1/40; H04R 29/00

(52) U.S. Cl. 381/97; 381/56

(57) ABSTRACT

A method of providing sounds in phase to a listener in an audio system by adjusting sounds with respect to the position of the listener includes generating first and second audio signals having identical magnitudes and opposite phases, and delaying the first audio signal from the second audio signal for a time corresponding to a predetermined delay constant, providing the first and second audio signals to first and second sound transform units, respectively, collecting a synthesized sound generated through a synthesis of first and second sounds corresponding to the first and second audio signals from the position of the listener, and determining a magnitude of the synthesized sound, and obtaining a delay constant to minimize the magnitude of the synthesized sound by repeatedly performing the generating of the first and second audio signals, the providing of the first and second signals, and the determining of the magnitude of the synthesized sound with a plurality of delay constant values; and an apparatus to perform the method.

### CROSS-REFERENCE TO RELATED APPLICATIONS

This application claims priority under 35 U.S.C. §119(a) from Korean Patent Application No. 10-2006-0073761, filed on Aug. 4, 2006, in the Korean Intellectual Property Office, the disclosure of which is incorporated herein in its entirety by reference.

### BACKGROUND OF THE INVENTION

1. Field of the Invention

The present general inventive concept relates to an audio system, and more particularly, to a method and apparatus to provide sounds in phase to a listener in an audio system with a plurality of speakers by adjusting sounds generated in respective speakers with respect to a position of the listener.

2. Description of the Related Art

A quality of sound provided to a user is determined by relative orientations of speakers generating sounds with respect to a listener, as well as a quality of an audio reproducing apparatus. In an audio system with a plurality of speakers, a difference between a distance from a listener to a left speaker and a distance from the listener to a right speaker makes the listener feel a phase difference of sound, i.e., the difference of the phase of sound.

FIG. 1 is a diagram illustrating an example of relative orientations of speakers with respect to a listener 40.

Referring to FIG. 1, a distance d1 between the listener 40 and a left speaker 10 is less than a distance d2 between the listener 40 and a right speaker 20. If an identical signal generated in an audio signal generation unit 30 is provided to both of the left speaker 10 and the right speaker 20, the sound generated in the left speaker 10 arrives at the listener 40 faster than the sound generated in the right speaker 20. That is, the sound generated in the left speaker 10 and the sound generated in the right speaker 20 arrive at the listener 40 at different points in time. This difference between the arrival times makes the listener 40 feel the difference of a phase of the sound from the left and right speakers 10 and 20.

This phase difference makes the listener 40 experience an awkward feeling and becomes inconvenienced thereby. Accordingly, a method of solving this phase difference and providing sounds in phase to the listener 40 has been needed.

A place where a listener can listen to sound comfortably is referred to as a ‘sweet spot’. Making the position of the listener a sweet spot (as opposed to moving the listener to a different position having the sweet spot) can be expressed as making a sweet spot at the listener position. Providing sounds in phase to the listener is one requirement for making a sweet spot at the listener's position. In order to make a sweet spot at the listener's position, a process of sensing the position of the listener is first performed. FIGS. 2 and 3 illustrate two examples of sensing a position of a listener.

FIG. 2 is a block diagram illustrating a conventional pulse-type position sensor.

Referring to FIG. 2, a pulse generator 52 of a digital signal processor (DSP) 66 generates a pulse. A switch 54 selects one channel and provides the generated pulse along the selected channel. If the channel of a left speaker 57 is selected, the pulse is provided to the left speaker 57 through a digital-to-analog converter (DAC) 55 and an amplifier of the left speaker 57. The left speaker 57 generates sound and outputs the sound.

A microphone 60 is disposed at a position of a listener. The microphone 60 receives the sound generated by the pulse from the left speaker 57. The received sound is transferred from the microphone 60 to an audio system 50 through a wire 61. Specifically, the received sound is transferred to an analyzer 64 through an analog-to-digital converter (ADC) 62.

In the case of the pulse-type position sensor, the analyzer 63 measures a pulse delay of the left speaker 57. The pulse delay is a time taken by the sound generated by the pulse from an instant the sound is output from a speaker to an instant the sound is received again by the audio system 50. If the pulse delay of the left speaker 57 is known, a distance from the left speaker 57 to the microphone 60 is calculated.

Then, the switch 54 selects the channel of a right speaker 58. In this case, the pulse is provided to the right speaker 58 though the DAC 56 and an amplifier of the right speaker 58. A pulse delay with respect to the right speaker 58 is also measured, and a distance between the right speaker 58 to the microphone 60 is calculated.

If the distance from the microphone 60 to each speaker is known in this way, during an operation for reproducing audio sounds, a delay in an audio path can be compensated for so that all signals arriving at the listener can be in phase.

FIG. 3 is a block diagram illustrating a conventional correlation-type position sensor.

The method illustrated in FIG. 3 is similar to that illustrated in FIG. 2, but a noise generator 70 is used instead of the pulse generator 52. Also, while the analyzer 64 for measuring a pulse delay is used in the pulse method, an analyzer 72 for calculating a correlation is used in the method illustrated in FIG. 3. That is, the digital signal processor (DSP) 66 generates a noise, and correlates this generated noise with a signal received in a microphone. A maximum value of a correlation function corresponds to a delay in a signal path. By using this delay in the signal path, a distance from each speaker 57 and 58 to the microphone 60 is calculated.

A problem with the positions sensors illustrated in FIGS. 2 and 3 is that the wire 61 is required in order to transfer the output of the microphone 60 to the ADC 62. That is, in order to sense the position of the listener, the wire 61 connected to the microphone 60 should be connected to the audio system 50, which causes an inconvenience to a user. Also, according to the conventional methods, complicated calculations should be performed. In order to calculate the pulse delay or correlations, a DSP 66 for performing the complicated calculations is required. Accordingly, the audio system 50 becomes complicated and has a high cost.

### SUMMARY OF THE INVENTION

The present general inventive concept provides a method and apparatus capable of providing sounds in phase to a listener in an audio system by adjusting sounds generated in respective speakers with a simple configuration and low cost.

The present general inventive concept also provides a computer readable recording medium having embodied therein a computer program to execute the method of providing sounds in phase.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of providing sounds in phase to a listener using an audio system by adjusting signals corresponding to the sounds with respect to a position of the listener, the method including generating first and second audio signals having identical magnitudes and opposite phases, and delaying the first audio signal from the second audio signal for a time corresponding to a predetermined delay constant, providing the first and second audio signals to first and second sound transform units, respectively, collecting a synthesized sound at the position of the listener generated through a synthesis of first and second sounds generated in the first and second sound transform units corresponding to the first and second audio signals, and determining a magnitude of the synthesized sound, and obtaining a delay constant to minimize the magnitude of the synthesized sound by repeatedly performing the generating of the first and second audio signals, the providing of the first and second audio signals, and the determining of the magnitude of the synthesized sound with a plurality of delay constant values.

The generating of the first and second audio signals and the providing of the first and second audio signals to the first and second sound transform units may be performed in a main system of the audio system, and the determining of the magnitude of the synthesized sound may be performed in a remote controller of the audio system.

The method may further include transmitting the determined magnitude of the synthesized sound from the remote controller to the main system.

The transmitting of the determined magnitude of the synthesized sound may include transmitting the determined magnitude of the synthesized sound using an infrared channel.

The infrared channel may be an infrared channel used in a remote controller to transmit a command to control the audio system.

The transmitting of the determined magnitude of the synthesized sound may include transmitting the determined magnitude of the synthesized sound using a radio frequency channel.

The determining of the magnitude of the synthesized sound may include measuring the magnitude of the synthesized sound, and converting the measured magnitude into digital information. The measuring of the magnitude of the synthesized sound may include measuring a root mean square value of the synthesized sound.

The obtaining of the delay constant to minimize the magnitude of the synthesized sound may include obtaining a delay constant to minimize the magnitude of the synthesized sound when the first audio signal to be provided to the first sound transform unit is delayed, and obtaining a delay constant to minimize the magnitude of the synthesized sound when the second audio signal to be provided to the second sound transform unit is delayed.

The method may further include delaying the first audio signal to be provided to the first sound transform unit or the second audio signal to be provided to the second sound transform unit using the delay constant to minimize the magnitude of the synthesized sound.

The foregoing and/or other aspects and utilities of the present general inventive concept may also be achieved by providing an to provide sounds in phase to a listener using an audio system by adjusting signals corresponding to the sounds with respect to a position of the listener, the apparatus including an audio signal generation unit to generate two identical audio signals, an audio signal modification unit to modify the two identical audio signals to generate first and second audio signals having identical magnitudes and opposite phases, to delay the first audio signal from the second audio signal for a time corresponding to a predetermined delay constant, and to provide the first and second audio signals to first and second sound transform units, respectively, a sound magnitude determination unit to collect a synthesized sound from the position of the listener generated by a synthesis of first and second sounds corresponding to the first and second audio signals generated in the first and second sound transform units, and to determine a magnitude of the synthesized sound, and a control unit to obtain a delay constant to minimize the magnitude of the synthesized sound by controlling the audio signal generation unit, the audio signal modification unit, and the sound magnitude determination unit to repeatedly operate using a plurality of delay constants.

The audio signal generation unit may be an audio source of the audio system or a separate noise generator.

The audio signal modification unit may include, an inverter to modify a phase of one signal of the first and second audio signals generated in the audio signal generation unit to have the opposite phase, and a signal delay unit to delay the one signal of the first and second audio signals for the time corresponding to the predetermined delay constant.

The audio signal generation unit, the audio signal modification unit, and the control unit may be included in a main system of the audio system, and the sound magnitude determination unit may be included in a remote controller of the audio system.

The sound magnitude determination unit may include, a sound collection unit to collect the synthesized sound and to transform the synthesized sound into an electrical signal, a sound magnitude measuring unit to measure the magnitude of the electrical signal, and an analog-to-digital converter unit to convert the measured magnitude of the electrical signal into digital information. The sound collection unit may be a microphone.

The sound magnitude measuring unit may include a root mean square measuring unit to measure a root mean square value of the synthesized sound.

The sound magnitude determination unit may include a sound magnitude transmission unit to transmit the measured magnitude of the electrical signal to a main system of the audio system.

The sound magnitude transmission unit may include an infrared signal transmission unit to transmit the determined magnitude of the synthesized sound using an infrared channel. The infrared channel may be an infrared channel used in a remote controller to transmit a command to control the audio system.

The sound magnitude transmission unit may transmit the determined magnitude of the synthesized sound using a radio frequency channel.

The control unit may obtain a first minimum magnitude of the synthesized sound and delays an audio signal to be provided to the first sound transform unit, and obtains a second minimum magnitude of the synthesized sound and delays an audio signal to be provided to the second sound transform unit, and determines the delay constant based on a smaller value of the first and second minimum magnitudes to minimize the magnitude of the synthesized sound.

The foregoing and/or other aspects and utilities of the present general inventive concept may also be achieved by providing an apparatus to provide a listener with sounds in phase, including a main system to generate two identical audio signals, to modify the two identical audio signals to generate first and second different audio signals having identical magnitudes and opposite phases, and to transform the first and second different audio signals into first and second sounds, and a sound magnitude determining unit to receive a synthesized sound generated from a synthesis of the first and second sounds, to measure a magnitude of the synthesized sound, and to remotely transmit the measured magnitude to the main system to control the generating, modifying, and transforming operations.

The main system may include an audio signal generating unit to generate the two identical audio signals, an audio signal modification unit to receive the two identical signals from the audio signal generating unit and to modify the two identical audio signals to generate the first and second different audio signals, and first and second transform units to receive the first and second different audio signals, respectively, from the audio signal modification unit, and to transform the first and second different audio signals into the first and second sounds, respectively.

The main system may further include a sound magnitude receiving unit to receive the measured magnitude remotely transmitted from the sound magnitude determining unit, and a control unit to generate a delay constant based on the received magnitude, and to delay one of the first and second different sound signals for a predetermined period of time corresponding to the delay constant.

The sound magnitude determining unit may include a sound receiving unit to receive the synthesized sound and to generate an electrical signal corresponding to the synthesized sound, a measuring unit to measure a magnitude of the electrical signal corresponding to the magnitude of the synthesized sound, and a transmitting unit to remotely transmit the measured magnitude to the main system.

The foregoing and/or other aspects and utilities of the present general inventive concept may also be achieved by providing a method of providing a listener with sounds in phase, the method including generating two identical audio signals in a main system of an audio apparatus, modifying the two identical audio signals in the main system to generate first and second different audio signals having identical magnitudes and opposite phases, transforming the first and second different audio signals in the main system into first and second sounds, receiving a synthesized sound generated from a synthesis of the first and second sounds in a sound magnitude determination unit of the audio apparatus, measuring a magnitude of the synthesized sound in the sound magnitude determination unit, and remotely transmitting the measured magnitude to the main system.

The transforming of the first and second different audio signals may include receiving the first and second different audio signals in first and second transform units of the main system, respectively, and transforming the first and second different audio signals into the first and second sounds in the first and second transform units, respectively.

The method may further include receiving the measured magnitude remotely transmitted from the sound magnitude determining unit in the main system, and generating a delay constant in the main system based on the received magnitude to delay one of the first and second different sound signals for a predetermined period of time corresponding to the delay constant.

The receiving of the synthesized sound may include receiving the synthesized sound and generating an electrical signal corresponding to the synthesized sound, and the measuring of the magnitude of the synthesized sound may include measuring a magnitude of the electrical signal corresponding to the magnitude of the synthesized sound.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram illustrating an example of relative orientations of speakers and a listener;

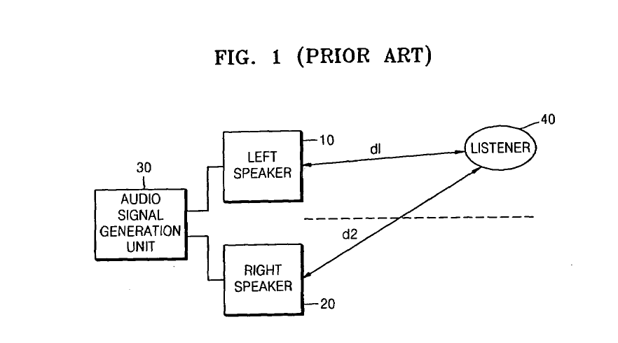

FIG. 2 is a block diagram illustrating a conventional pulse-type position sensor;

FIG. 3 is a block diagram illustrating a conventional correlation-type position sensor;

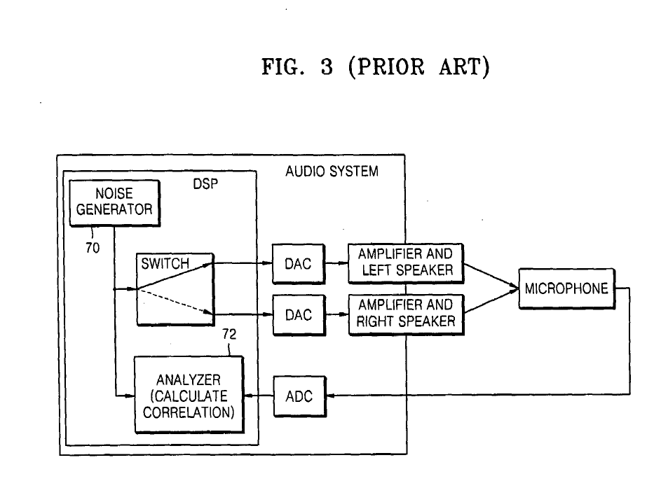

FIG. 4 is a block diagram illustrating an apparatus to provide sounds in phase, according to an embodiment of the present general inventive concept;

FIGS. 5A and 5B are flowcharts illustrating a method of providing sounds in phase, according to an embodiment of the present general inventive concept;

FIG. 6 is a diagram illustrating waveforms of sounds generated in respective sound transform units and a synthesized sound collected in a sound collection unit, according to an embodiment of the present general inventive concept;

FIG. 7 is a diagram illustrating audio paths in relation to different listeners, according to an embodiment of the present general inventive concept; and

FIG. 8 is a diagram illustrating equidistant positions relative to two speakers, according to an embodiment of the present general inventive concept;

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

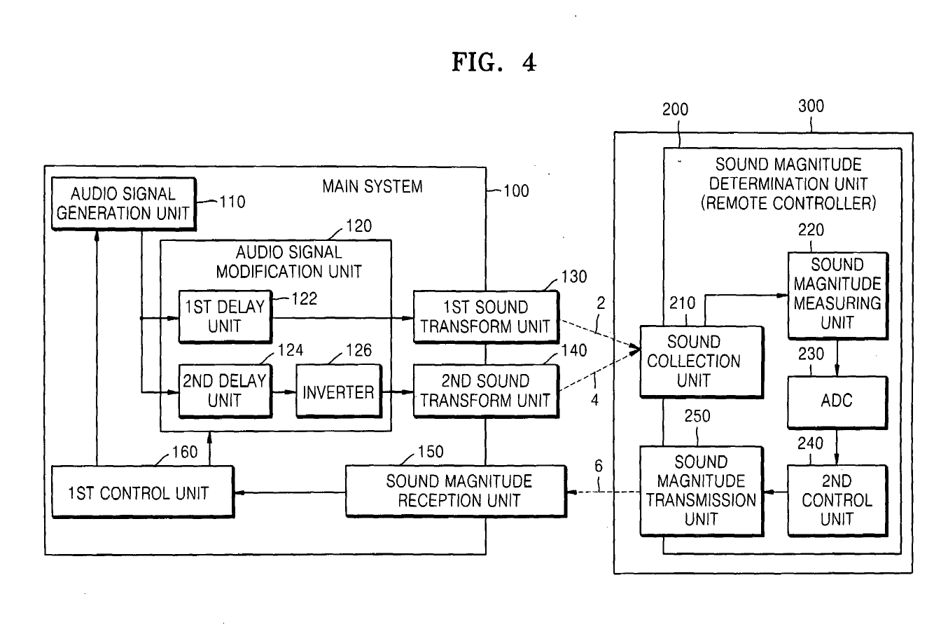

FIG. 4 is a block diagram illustrating an apparatus to provide sounds in phase, according to an embodiment of the present general inventive concept.

Referring to FIG. 4, the apparatus to provide sounds in phase according to the present embodiment may include a main system 100 including an audio signal generation unit 110, an audio signal modification unit 120, a first sound transform unit 130, a second sound transform unit 140, a sound magnitude reception unit 150, and a first control unit 160, and a sound magnitude determination unit 200.

In general, an audio system is composed of the main system 100 and a remote controller 300, which may include the sound magnitude determination unit 200. However, the sound magnitude determination unit 200 is not required to be part of the remote controller 300, and the present general inventive concept does not require the remote controller 300.

The main system 100 is a main body of the audio system, and generates an audio signal and provides the audio signal to an audio transducer such that sound is generated. The audio signal generation unit 110, the audio signal modification unit 120, the first and second sound transform units 130 and 140, the sound magnitude reception unit 150, and the first control unit 160 according to the present embodiment may be included in the main system 100, as illustrated in FIG. 4. Moreover, the first and second sound transform units 130 and 140 may be used as the audio transducer.

The remote controller 300 is a remote control device that a user may use to remotely (as opposed to manually) control functions of the main system 100. The remote controller 300 may be of a small size with a light weight. The sound magnitude determination unit 200 according to the present embodiment is illustrated in FIG. 4 as being included in a remote controller. However, the sound magnitude determination unit 200 is not required to be included in the remote controller 300, and the remote controller 300 is not required to control the functions of the main system 100. The remote controller 300 may use an infrared channel, and an apparatus to receive an infrared signal from the remote controller 300 may be included in the main system 100.

According to the present embodiment the apparatus to provide sounds in phase uses a simple calculation and does not use a wire between a microphone and an audio system, and thus reduces a complexity and cost of the apparatus of the present embodiment as compared to a conventional apparatus. Specifically, the present embodiment employs a structure in which a sound collection unit 210 is disposed inside a remote controller 300 of the audio system.

The audio signal generation unit 110 generates two identical audio signals. Specifically, an audio signal is generated by the audio signal generation unit 110 and provided to a channel for a left sound transform unit (e.g., the first sound transformation unit 130) and a channel for a right sound transform unit (e.g., the second sound transformation unit 140). An audio source of an audio system can be used as the audio signal generation unit 110. For example, the audio signal generation unit 110 may be one of the following audio sources: a cassette tape player, a CD player, and a radio tuner. Alternatively, a separate noise generator may be used as the audio signal generation unit 110. However, the audio signal generation unit 110 is not limited to being one of these specific examples.

The audio signal modification unit 120 transforms the audio signal generated in the audio signal generation unit 110 and thus generates two audio signals having identical magnitudes but opposite phases, with one signal of the two signals being delayed from the other signal. For this, the audio signal modification unit 120 may include a first delay unit 122, a second delay unit 124 and an inverter 126.

The first delay unit 122 and the second delay unit 124 each delay one of the audio signals from the audio signal generation unit 110. Here, a delay constant is specified by the first control unit 160. According to which of the first and second sound transform units 130 and 140 a delay will be applied, the delay constant is specified for one of the first and second delay units 122 and 124.

The inverter 126 makes the phase of one of the two audio signals opposite to the other of the two audio signals. In the example illustrated in FIG. 4, the audio signal from the second delay unit 124 is provided to the inverter 126. However, the inverter 126 may also be disposed after the first delay unit 122 (in addition to being disposed after the second delay unit 124), or may be disposed before only one of the first delay unit 122 or the second delay unit 124. That is, the phase of either one of the two audio signals may be made to be opposite to the phase of the other one of the two audio signals. Also, an order in which the delaying and inverting of an audio signal is performed is not limited. However, the two audio signals should have opposite phases, and one of the two signals should be delayed for a time corresponding to a predetermined delay constant.

The two audio signals output from the audio signal modification unit 120 are provided to the first sound transform unit 130 and the second sound transform unit 140, respectively. The sound transform units 130 and 140 transform the audio signals that are electrical signals into sounds 2 and 4. A representative example of the sound transform unit (i.e., the first and second sound transform units 130 and 140) is a speaker. However, the sound transform unit(s) of the present embodiment is/are not limited to a speaker. The term ‘speaker’ refers to the sound transform unit, and also refers to any apparatus that can transform an audio signal into a sound and provide the sound to a listener.

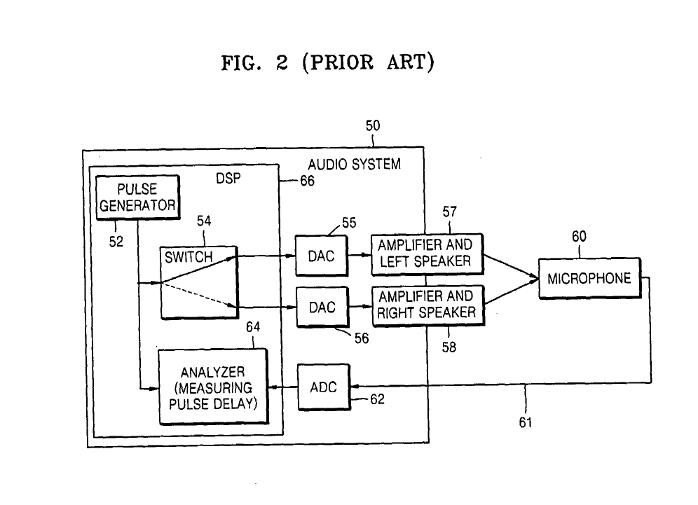

According to the conventional technology, the switch 54 as illustrated in FIG. 2 is disposed in the audio system 50 and selects one of the left and right channels so that a pulse or noise is provided to one speaker. However, in the present embodiment, two audio signals are generated and (if the delay according to the delay constant is excluded) are provided almost simultaneously to respective sound transform units 130 and 140, in contrast to the conventional technology.

The sound magnitude determination unit 200 collects a synthesized sound generated from the sounds generated in the sound transform units 130 and 140. The sound magnitude determination unit 200 may include the sound collection unit 210, a sound magnitude measuring unit 220, an analog-to-digital converter (ADC) 230, a second control unit 240, and a sound magnitude transmission unit 250.

The sound magnitude determination unit 200 according to the present embodiment may be included in a remote controller of an audio system, such as the remote controller 300 optionally illustrated in FIG. 4. The sound magnitude transmission unit 250 may be an infrared signal transmission unit to transmit the determined magnitude of the synthesized sound using an infrared channel, such as an infrared signal that is generally used in a remote controller to transmit a command to control an audio system.

In this way, the apparatus to provide sound in phase of the present embodiment does not require a connection of a microphone to a main body by a listener in order to listen to sounds in phase, in contrast to the conventional technology. Without the listener manipulating the sound magnitude determination unit 200 (e.g., without the listener manipulating the remote controller 300), the apparatus according to the present embodiment automatically calculates a required delay constant and uses the delay constant to provide sounds in phase.

A special structure is not required in the sound magnitude determination unit 200 to synthesize the two sounds 2 and 4 respectively generated by the first and second transformation units 130 and 140. The sounds 2 and 4 respectively generated in the sound transform units 130 and 140 are transferred to the place (position) of the listener, and according to the principle of superposition, the synthesized sound generated through synthesis of the two sounds 2 and 4 arrives at the position of the listener. If the listener has the remote controller 300 at the position of the listener, the position of the remote controller 300 becomes the position of the listener.

The sound collection unit 210 collects the synthesized sound arriving at the position of the listener and transforms the synthesized sound into an electrical signal. The sound collection unit 210 may be, for example, a microphone. Even without a separate manipulation by the listener, when the remote controller 300 is placed at the position of the listener, the synthesized sound arrives at the sound collection unit 210 at the position of the listener and can be simply collected. Thus, according to the present embodiment, only a determination of a magnitude of the synthesized sound is necessary. Accordingly, a low-price and low-quality microphone can be used as the sound collection unit 210.

The sound magnitude measuring unit 220 measures a magnitude of the electrical signal transformed from the synthesized sound by the sound collection unit 210. The sound magnitude measuring unit 220 may be, for example, a root mean square (RMS) measuring device to measure an RMS value of an output of the sound collection unit 210 (e.g., microphone), or an amplitude detector.

The magnitude of the electrical sound signal measured in the sound magnitude measuring unit 220 is converted into a digital signal in the ADC 230, which can be easily transmitted in the sound magnitude transmission unit 250.

The magnitude of the sound converted into the digital signal (as the digital signal) is transferred from the ADC 230 to the second control unit 240. The second control unit 240 transfers the magnitude of the digitally converted electrical sound signal to the sound magnitude transmission unit 250 so that the magnitude can be transmitted to the main system 100. The second control unit 240 may be identical to a microcontroller to generate a command in a remote controller, such as the remote controller 300 illustrated in FIG. 4, in order to control an audio system. However, the second control unit 240 is not limited to being identical to the microcontroller of a remote controller.

The sound magnitude transmission unit 250 transfers the determined magnitude 6 of the synthesized sound to the main system 100. The sound magnitude transmission unit 250 may be, for example, an infrared signal transmission unit to transmit the magnitude of a synthesized sound using an infrared channel. However, the present general inventive concept is not limited to this, and may include a radio frequency (RF) signal transmission unit to transfer the magnitude of the synthesized sound using an RF channel.

Since only the magnitude of the synthesized sound is determined and transferred to the main system 100 without transferring the synthesized sound itself, the present embodiment does not require complicated processors and wires as in the conventional technology, and the sound magnitude determination unit 200 can be included in the remote controller 300.

The sound magnitude reception unit 150 receives the magnitude of the synthesized sound determined and transferred by the sound magnitude determination unit 200. A reception method of the sound magnitude reception unit 150 may be determined according to a transmission method of the sound magnitude transmission unit 250. For example, if the sound magnitude transmission unit 250 transmits the magnitude of the synthesized sound using an infrared channel, the sound magnitude reception unit 150 may use an infrared signal reception apparatus to receive the magnitude of the synthesized sound from the sound magnitude transmission unit 250. Alternatively, if the sound magnitude transmission unit 250 transmits the magnitude of the synthesized sound through an RF channel, the sound magnitude reception unit 150 may use an RF signal reception apparatus to receive the magnitude of the synthesized sound from the sound magnitude transmission unit 250.

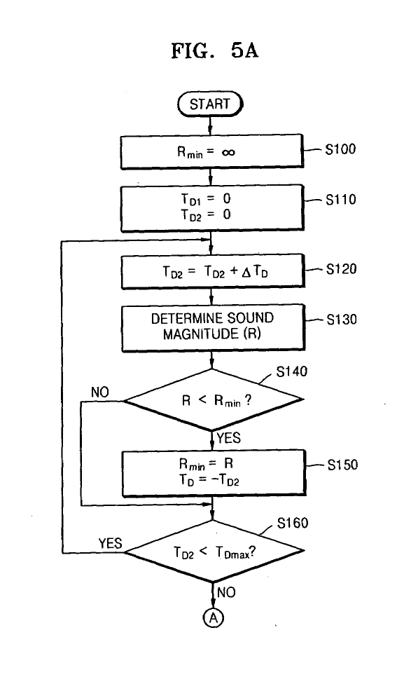

The first control unit 160 controls the audio signal generation unit 110, the audio signal modification unit 120, and the sound magnitude determination unit 200. The first control unit 160 controls these elements so that these elements repeatedly perform a generation, a modification, and a transfer of an audio signal, and a determination of the magnitude of a synthesized sound generated from the audio signal. Through this process, a delay constant to minimize a magnitude of the synthesized sound is determined. This iterative performing of the operations of this process, according to an embodiment of the present general inventive concept, will now be described with reference to FIGS. 4, 5A, and 5B.

FIGS. 5A and 5B are flowcharts illustrating a method of providing sounds in phase, according to an embodiment of the present general inventive concept.

In FIGS. 5A and 5B, TD1 and TD2 are the delay constant values specified by the first delay unit 122 and the second delay unit 124, respectively. R is the magnitude value of the synthesized sound transmitted from the second control unit 240 to the first control unit 160. Rmin is a minimum value of R. ΔTD is an incremental value for TD1 and TD2. TDmax is a maximum value of TD1 and TD2. TD is a search parameter.

While delaying a first audio signal to be provided to the first sound transform unit 130 from the audio signal generation unit 110, the first control unit 160 obtains a delay constant TD1 having a minimum magnitude Rmin of the synthesized sound, as illustrated in FIG. 5A. Then, while delaying a second audio signal to be provided to the second sound transform unit 140 from the audio signal generation unit 110, the first control unit 160 obtains a delay constant TD2 having the minimum magnitude Rmin of the synthesized sound, as illustrated in FIG. 5B. Through this process, a delay constant having a minimum magnitude of the synthesized sound as a whole can be obtained.

First, in order to find a minimum value of the R, the Rmin is set as infinite in operation S100. Then, the values of TD1 and TD2 each are set to 0 in operation S110. These two operations initialize the main system 100. Then, operations S120 through S160 are iteratively performed to obtain a delay constant TD2 having a minimum magnitude of the synthesized sound when the first audio signal to be provided to the first sound transform unit 130 is delayed.

Specifically, the incremental value ΔTD is added to TD2 in operation S120. The first delay unit 122 delays the first audio signal for a time corresponding to the TD2 and then provides the first audio signal to the first sound transform unit 130. The second delay unit 124 does not delay the second audio signal at this time. Accordingly, the sound generated in the first sound transform unit 130 and the sound generated in the second sound transform unit 140 have a time difference corresponding to the delay constant TD2.

The sound magnitude determination unit 200 collects the synthesized sound synthesized from the sound generated in the first sound transform unit 130 and the sound generated in the second sound transform unit 140, and determines the magnitude R of the synthesized sound in operation S130.

The determined magnitude R of the synthesized sound is compared with the Rmin value in operation S140. If the determined magnitude R of the synthesized sound is less than the Rmin value, the determined magnitude R of the synthesized sound is the minimum value among all magnitude values measured up to that time point, this determined minimum value is stored as the Rmin value, and −TD2 (obtained by multiplying the current delay constant TD2 by −1) is stored as the TD in operation S150. If the determined magnitude R of the synthesized sound is equal to or greater than the Rmin value, operation S150 is not performed and the method continues to operation S160.

The delay constant TD2 is compared with the TDmax in operation S160. If the delay constant TD2 is less than the TDmax, operations S120 through S160 are performed again. If the delay constant TD2 is equal to or greater than the TDmax, it means that the delay constant TD2 that is equal to or greater than the TDmax is the delay constant that generates the minimum magnitude of sound in the first sound transform unit 130. In this case, an identical process is iteratively performed in relation to the second sound transform unit 140.

Specifically, in order to find a delay constant generating a minimum magnitude of the synthesized sound in relation to the second sound transform unit 140, the values of TD1 and TD2 each are set to 0 for initialization in operation S170.

The incremental value ΔTD is added to TD1 in operation S180. The second delay unit 124 delays the second audio signal for a time corresponding to the delay constant TD1 and then provides the second audio signal to the second sound transform unit 140. The first delay unit 122 does not delay the first audio signal at this time. Accordingly, the sound generated in the second sound transform unit 140 and the sound generated in the first sound transform unit 130 have a time difference corresponding to the delay constant TD1.

The sound magnitude determination unit 200 collects the synthesized sound synthesized from the sound generated in the first sound transform unit 130 and the sound generated in the second sound transform unit 140, and determines the magnitude R of the synthesized sound in operation S190.

The determined magnitude R of the synthesized sound is compared with the Rmin value in operation S200. If the determined magnitude R of the synthesized sound is less than the Rmin value, the determined magnitude R of the synthesized sound is determined to be the minimum value among all magnitude values measured up to that time point, this determined minimum value is stored as the Rmin value, and the current delay constant TD1 is stored as the TD in operation S210. If the determined magnitude R of the synthesized sound is equal to or greater than the Rmin value, operation S210 is not performed and the method continues to operation S220.

The delay constant TD1 is compared with the TDmax in operation S220. If the delay constant TD1 is less than the TDmax, operations S180 through S220 are performed again. If the delay constant TD1 is equal to or greater than the TD2, it means that the delay constant TD1 that is equal to or greater than the TD max is the delay constant that generates the minimum magnitude of sound in the second sound transform unit 140.

In the method illustrated in FIG. 5B, a minimum magnitude Rmin1 of the first sound obtained by delaying the first audio signal to be provided to the first sound transform unit 130 is obtained and is compared with a magnitude of the second sound obtained by delaying the second audio signal to be provided to the second sound transform unit 140, thereby finding a delay constant generating a minimum magnitude of sound Rmin.

Alternatively, Rmin1 in relation to the first sound transform unit 130 is obtained and a minimum magnitude Rmin2 of the second sound obtained by delaying the second audio signal to be provided to the second sound transform unit 140 is obtained. Then, a delay constant corresponding to a smaller value of Rmin1 and Rmin2 may be determined as a delay constant generating a minimum magnitude of sound Rmin.

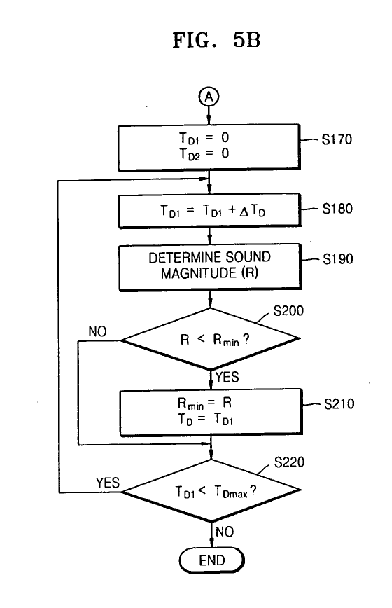

A principle of providing sounds in phase when a synthesized sound generated from the sounds 2 and 4 respectively generated in the two sound transform units 130 and 140 has a minimum magnitude of sound Rmin will now be described with reference to FIGS. 4 and 6.

FIG. 6 is a diagram illustrating waveforms of sounds generated in respective sound transform units and a synthesized sound collected in a sound collection unit, according to an embodiment of the present general inventive concept.

When the first sound generated in the first sound transform unit 130 arrives at the sound collection unit 210, the first sound has a waveform as indicated by reference number 7. When the second sound generated in the second sound transform unit 140 arrives at the sound collection unit 210, the second sound has a waveform as indicated by reference number 8. Thus, one of the first and second sounds is delayed by the corresponding delay unit 122 or 124 delaying the corresponding first or second audio signal in advance, and the other of the first and second sounds is delayed by a difference between the corresponding sound transform unit 130 or 140 and the sound collection unit 210. In this way, the two sounds are caused to be in phase.

If two sounds having opposite phases are made to be in phase, the synthesized sound having a magnitude value of near 0 as indicated by reference number 9 arrives at the listener. Meanwhile, if the value of the delay constant has a value other than a delay constant value generating the Rmin, two sounds having different phases arrive at the sound collection unit 210, and thus the magnitude of the synthesized sound does not become a minimum value.

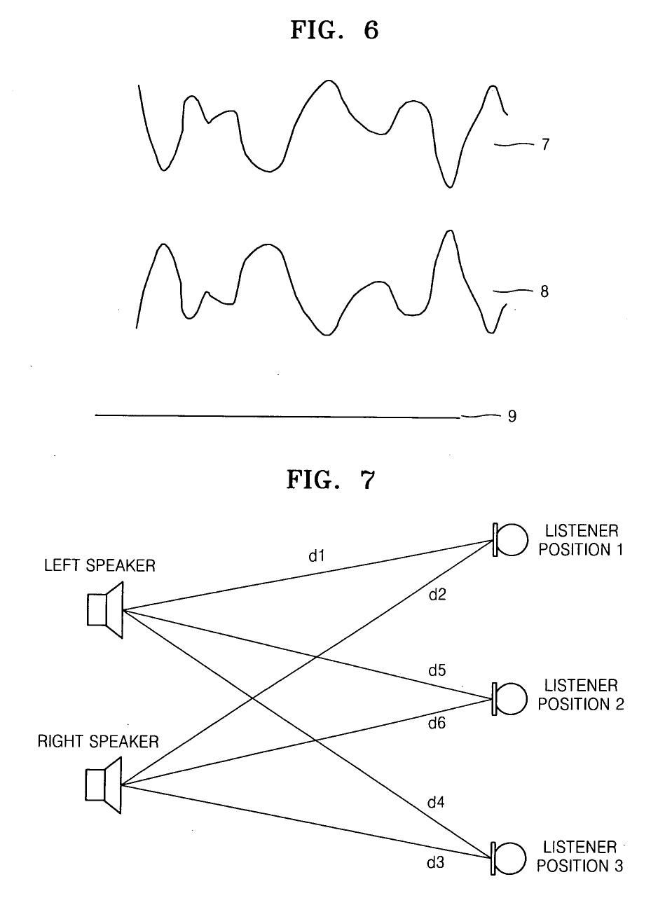

FIG. 7 is a diagram illustrating audio paths in relation to different listeners, according to an embodiment of the present general inventive concept.

If the sound magnitude determination unit 200 (e.g., the remote controller 300 including the sound magnitude determination unit 200) is placed at listener position 1, a distance d1 from a left speaker is less than a distance d2 from a right speaker. Accordingly, an audio signal provided to the left speaker should be delayed. Similarly, if the remote controller 300 is placed at listener position 3, a distance d3 from the right speaker is less than a distance d4 from the left speaker. Accordingly, an audio signal provided to the right speaker should be delayed. On the other hand, if the remote controller 300 is placed at listener position 2, a distance d5 from the left speaker is the same as a distance d6 from the right speaker. Accordingly, the delay constant is 0 and neither of the audio signals provided to the left and right speakers should be delayed.

A delay value is the same as a value obtained by dividing a difference in distances of the two audio paths by a velocity of sound. However, a method and apparatus to provide sounds in phase according to embodiments of the present general inventive concept do not require this calculation. Instead, by obtaining a delay constant to minimize a magnitude of a synthesized sound, a suitable delay value can be found even without the calculation.

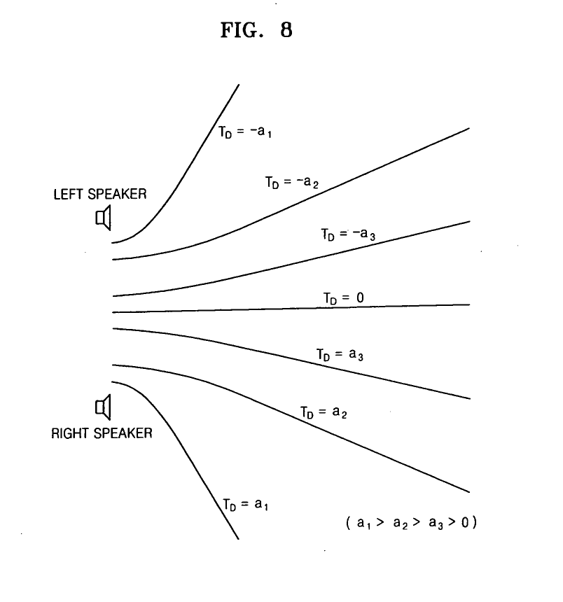

FIG. 8 is a diagram illustrating equidistant positions relative to two speakers, according to an embodiment of the present general inventive concept. Equidistant curves in relation to left and right speakers form hyperbolas corresponding to each delay constant TD. If a value (such as a1, a2, a3, 0, −a1, −a2, or −a3, as illustrated in FIG. 8) of the delay constant TD is known, a position of a listener (or more precisely, an orientation of the listener) can be known.

In the conventional technology, a distance from each speaker to a microphone is calculated by performing complicated calculations, such as pulse delay or correlation calculations. However, in a method and apparatus to provide sounds in phase according to embodiments of the present general inventive concept, pulse delays or distances from respective speakers are not calculated and a delay time to make sounds in phase is directly calculated. In this way, a structure of a device is simplified and a cost is lowered. Also, since only a measuring of the magnitude of sound is required, a sound magnitude collection device may be included inside of a remote controller. Accordingly, a listener avoids an inconvenience of connecting wires.

In a method of providing sounds in phase according to embodiments of the present general inventive concept, an audio system may be a part of, for example, a TV or a home theater system. The method can provide sounds in phase to a listener through a slight modification to the audio system. For example, a speaker may be disposed inside a TV and the TV may have a motor to rotate a case together with embedded speakers. In this case, a system according to embodiments of the present general inventive concept can adjust an angle of a screen and/or speakers of the TV so that the screen and/or speakers face the position (orientation) of the listener. Here, instead of changing a delay constant until a minimum magnitude synthesized sound is obtained, changing the position (angle) between the system and the listener can be repeatedly performed.

According to a method and apparatus to provide sounds in phase according to embodiments of the present general inventive concept, a magnitude of a synthesized sound is measured and a delay time to make sounds in phase is directly calculated, thereby providing sounds in phase to a listener with a simple structure and at a low cost. Also, since a sound collection device can be included inside a remote controller, the listener can avoid an inconvenience of connecting wires.

The present general inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of providing sounds in phase to a listener using an audio system by adjusting signals corresponding to the sounds with respect to a position of the listener, the method comprising:
generating first and second audio signals having identical magnitudes and opposite phases, and delaying the first audio signal from the second audio signal for a time corresponding to a predetermined delay constant;
providing the first and second audio signals to first and second sound transform units, respectively;
collecting a synthesized sound at the position of the listener generated through a synthesis of first and second sounds generated in the first and second sound transform units corresponding to the first and second audio signals, and determining a magnitude of the synthesized sound; and
obtaining a delay constant to minimize the magnitude of the synthesized sound by repeatedly performing the generating of the first and second audio signals, the providing of the first and second audio signals, and the determining of the magnitude of the synthesized sound with a plurality of delay constant values.

2. The method of claim 1, wherein:
the generating of the first and second audio signals and the providing of the first and second audio signals to the first and second sound transform units are performed in a main system of the audio system; and
the determining of the magnitude of the synthesized sound is performed in a remote controller of the audio system.

3. The method of claim 2, further comprising:
transmitting the determined magnitude of the synthesized sound from the remote controller to the main system.

4. The method of claim 3, wherein the transmitting of the determined magnitude of the synthesized sound comprises:
transmitting the determined magnitude of the synthesized sound using an infrared channel.

5. The method of claim 4, wherein the infrared channel is an infrared channel used in a remote controller to transmit a command to control the audio system.

6. The method of claim 3, wherein the transmitting of the determined magnitude of the synthesized sound comprises:
transmitting the determined magnitude of the synthesized sound using a radio frequency channel.

7. The method of claim 1, wherein the determining of the magnitude of the synthesized sound comprises:
measuring the magnitude of the synthesized sound; and
converting the measured magnitude into digital information.

8. The method of claim 7, wherein the measuring of the magnitude of the synthesized sound comprises:
measuring a root mean square value of the synthesized sound.

9. The method of claim 1, wherein the obtaining of the delay constant to minimize the magnitude of the synthesized sound comprises:
obtaining a delay constant to minimize the magnitude of the synthesized sound when the first audio signal to be provided to the first sound transform unit is delayed; and
obtaining a delay constant to minimize the magnitude of the synthesized sound when the second audio signal to be provided to the second sound transform unit is delayed.

10. The method of claim 1, further comprising:
delaying the first audio signal to be provided to the first sound transform unit or the second audio signal to be provided to the second sound transform unit using the delay constant to minimize the magnitude of the synthesized sound.

11. An apparatus to provide sounds in phase to a listener using an audio system by adjusting signals corresponding to the sounds with respect to a position of the listener, the apparatus comprising:
an audio signal generation unit to generate two identical audio signals;
an audio signal modification unit to modify the two identical audio signals to generate first and second audio signals having identical magnitudes and opposite phases, to delay the first audio signal from the second audio signal for a time corresponding to a predetermined delay constant, and to provide the first and second audio signals to first and second sound transform units, respectively;
a sound magnitude determination unit to collect a synthesized sound from the position of the listener generated by a synthesis of first and second sounds corresponding to the first and second audio signals generated in the first and second sound transform units, and to determine a magnitude of the synthesized sound; and
a control unit to obtain a delay constant to minimize the magnitude of the synthesized sound by controlling the audio signal generation unit, the audio signal modification unit, and the sound magnitude determination unit to repeatedly operate using a plurality of delay constants.

12. The apparatus of claim 11, wherein the audio signal generation unit is an audio source of the audio system or a separate noise generator.

13. The apparatus of claim 11, wherein the audio signal modification unit comprises:
an inverter to modify a phase of one signal of the first and second audio signals generated in the audio signal generation unit to have the opposite phase; and
a signal delay unit to delay the one signal of the first and second audio signals for the time corresponding to the predetermined delay constant.

14. The apparatus of claim 11, wherein the audio signal generation unit, the audio signal modification unit, and the control unit are included in a main system of the audio system, and the sound magnitude determination unit is included in a remote controller of the audio system.

15. The apparatus of claim 11, wherein the sound magnitude determination unit comprises:
a sound collection unit to collect the synthesized sound and to transform the synthesized sound into an electrical signal;
a sound magnitude measuring unit to measure the magnitude of the electrical signal; and
an analog-to-digital converter unit to convert the measured magnitude of the electrical signal into digital information.

16. The apparatus of claim 15, wherein the sound collection unit is a microphone.

17. The apparatus of claim 15, wherein the sound magnitude measuring unit comprises:
a root mean square measuring unit to measure a root mean square value of the synthesized sound.

18. The apparatus of claim 11, wherein the sound magnitude determination unit comprises:
a sound magnitude transmission unit to transmit the measured magnitude of the electrical signal to a main system of the audio system.

19. The apparatus of claim 18, wherein the sound magnitude transmission unit comprises:
an infrared signal transmission unit to transmit the determined magnitude of the synthesized sound using an infrared channel.

20. The apparatus of claim 19, wherein the infrared channel is an infrared channel used in a remote controller to transmit a command to control the audio system.

21. The apparatus of claim 18, wherein the sound magnitude transmission unit transmits the determined magnitude of the synthesized sound using a radio frequency channel.

22. The apparatus of claim 11, wherein the control unit obtains a first minimum magnitude of the synthesized sound and delays an audio signal to be provided to the first sound transform unit, and obtains a second minimum magnitude of the synthesized sound and delays an audio signal to be provided to the second sound transform unit, and determines the delay constant based on a smaller value of the first and second minimum magnitudes to minimize the magnitude of the synthesized sound.

23. A computer readable recording medium having embodied thereon a computer program to execute a method, the method comprising:
generating first and second audio signals having identical magnitudes and opposite phases, and delaying the first audio signal from the second audio signal for a time corresponding to a predetermined delay constant;
providing the first and second audio signals to first and second sound transform units, respectively;
collecting a synthesized sound from the position of the listener generated through a synthesis of first and second sounds generated in the first and second sound transform units corresponding to the first and second audio signals, and determining a magnitude of the synthesized sound; and
obtaining a delay constant to minimize the magnitude of the synthesized sound by repeatedly performing the generating of the first and second audio signals, the providing of the first and second signals, and the determining of the magnitude of the synthesized sound with a plurality of delay constant values.

24. A method of providing sounds in phase to a listener using an audio system by adjusting signals corresponding to the sounds with respect to a position of the listener, the method comprising:
generating first and second audio signals having identical magnitudes and opposite phases, and delaying the first audio signal from the second audio signal for a time corresponding to a predetermined delay constant;
providing the first and second audio signals to first and second sound transform units, respectively;
receiving a magnitude determined at the position of the listener of a synthesized sound generated through a synthesis of first and second sounds corresponding to the first and second audio signals generated in the first and second sound transform unit, respectively; and
obtaining a delay constant to minimize the magnitude of the synthesized sound by repeatedly performing the generating of the first and second audio signals, the providing the first and second audio signals, and the receiving of the magnitude of the synthesized sound with a plurality of delay constant values,
wherein the method is performed in a main system of the audio system.

25. A method of determining a magnitude of a synthesized sound to provide sounds in phase to a listener using an audio system by adjusting signals corresponding to the sounds with respect to a position of the listener, the method comprising:
collecting a synthesized sound generated through a synthesis of two sounds transferred to the position of the listener and determining a magnitude of the synthesized sound; and
transmitting the determined magnitude of the synthesized sound to a main system of the audio system,
wherein the method is performed in a remote controller of the audio system.

26. An apparatus to provide sounds in phase to a listener using an audio system by adjusting signals corresponding to the sounds with respect to a position of the listener, the apparatus comprising:
an audio signal generation unit to generate two identical audio signals;
an audio signal modification unit to modify the two audio signals to generate first and second audio signals having identical magnitudes and opposite phases, delaying the first audio signal from the second audio signal for a time corresponding to a predetermined delay constant, and providing the first and second audio signals to first and second sound transform units, respectively;
a sound magnitude reception unit to receive a magnitude determined at the position of the listener of a synthesized sound generated through a synthesis of first and second sounds corresponding to the first and second audio signals; and
a control unit to obtain a delay constant to minimize the magnitude of the synthesized sound by controlling the audio signal generation unit, the audio signal modification unit, and the sound magnitude reception unit to repeatedly operate using a plurality of delay constants,
wherein the apparatus is included in a main system of the audio system.

27. An apparatus to determine a magnitude of a synthesized sound to provide sounds in phase to a listener using an audio system by adjusting signals corresponding to the sounds with respect to a position of the listener, the apparatus comprising:
a sound collection unit to collect a synthesized sound generated through a synthesis of two sounds transferred to the position of the listener and to transform the synthesized sound into an electrical signal;
a sound magnitude measuring unit to measure a magnitude of the electrical signal to determine a corresponding magnitude of the synthesized sound;
an analog-to-digital converter unit to convert the measured magnitude of the synthesized sound into digital information; and
a sound magnitude transmission unit to transmit the determined magnitude of the synthesized sound to a main system of the audio system,
wherein the apparatus is included in a remote controller of the audio system.

28. An apparatus to provide a listener with sounds in phase, comprising:
a main system to generate two identical audio signals, to modify the two identical audio signals to generate first and second different audio signals having identical magnitudes and opposite phases, and to transform the first and second different audio signals into first and second sounds; and
a sound magnitude determining unit to receive a synthesized sound generated from a synthesis of the first and second sounds, to measure a magnitude of the synthesized sound, and to remotely transmit the measured magnitude to the main system to control the generating, modifying, and transforming operations.

29. The apparatus of claim 28, wherein the main system comprises:
an audio signal generating unit to generate the two identical audio signals;
an audio signal modification unit to receive the two identical signals from the audio signal generating unit and to modify the two identical audio signals to generate the first and second different audio signals; and
first and second transform units to receive the first and second different audio signals, respectively, from the audio signal modification unit, and to transform the first and second different audio signals into the first and second sounds, respectively.

30. The apparatus of claim 29, wherein the main system further comprises:
a sound magnitude receiving unit to receive the measured magnitude remotely transmitted from the sound magnitude determining unit; and
a control unit to generate a delay constant based on the received magnitude, and to delay one of the first and second different sound signals for a predetermined period of time corresponding to the delay constant.

31. The apparatus of claim 28, wherein the sound magnitude determining unit comprises:
a sound receiving unit to receive the synthesized sound and to generate an electrical signal corresponding to the synthesized sound;
a measuring unit to measure a magnitude of the electrical signal corresponding to the magnitude of the synthesized sound; and
a transmitting unit to remotely transmit the measured magnitude to the main system.

32. A method of providing a listener with sounds in phase, the method comprising:
generating two identical audio signals in a main system of an audio apparatus;
modifying the two identical audio signals in the main system to generate first and second different audio signals having identical magnitudes and opposite phases;
transforming the first and second different audio signals in the main system into first and second sounds;
receiving a synthesized sound generated from a synthesis of the first and second sounds in a sound magnitude determination unit of the audio apparatus;
measuring a magnitude of the synthesized sound in the sound magnitude determination unit; and
remotely transmitting the measured magnitude to the main system.

33. The method of claim 32, wherein the transforming of the first and second different audio signals comprises:
receiving the first and second different audio signals in first and second transform units of the main system, respectively; and
transforming the first and second different audio signals into the first and second sounds in the first and second transform units, respectively.

34. The method of claim 33, further comprising:
receiving the measured magnitude remotely transmitted from the sound magnitude determining unit in the main system; and
generating a delay constant in the main system based on the received magnitude to delay one of the first and second different sound signals for a predetermined period of time corresponding to the delay constant.

35. The apparatus of claim 32, wherein:
the receiving of the synthesized sound comprises receiving the synthesized sound and generating an electrical signal corresponding to the synthesized sound; and
the measuring of the magnitude of the synthesized sound comprises measuring a magnitude of the electrical signal corresponding to the magnitude of the synthesized sound.
